(19) United States
(12) Patent Application Publication
(10) Pub. No.: US 2020/0082524 A1
(43) Pub. Date: Mar. 12, 2020

(54) AUTOMATIC INSPECTING DEVICE

(71) Applicant: Furuno Electric Co., Ltd., Nishinomiya-City (JP)

(72) Inventors: Yasushi HIRAOKA, Nishinomiya (JP); Kentaro Tsudaka, Nishinomiya (JP)

(73) Assignee: Furuno Electric Co., Ltd., Nishinomiya-City (JP)

(21) Appl. No.: 16/681,362

(22) Filed: Nov. 12, 2019

Related U.S. Application Data
(63) Continuation-in-part of application No. PCT/JP2018/012371, filed on Mar. 27, 2018.

(30) Foreign Application Priority Data
May 9, 2017 (JP) 2017-092917

(51) Int. Cl. G06T 7/00; G06K 9/62

(52) U.S. Cl. CPC G06T 7/0006; G06K 9/6256; G06K 2209/01; G06T 2207/30121; G06T 2207/30144; G06K 9/6212

(57) ABSTRACT

An automatic inspecting device in which a change in an inspection scenario is unnecessary or little, even if an apparatus specification information is changed, is provided. An automatic inspecting device 20 includes a hardware processor 25. The hardware processor 25 converts processing to be performed by an inspection target apparatus 10 into a converted signal corresponding to apparatus specification information on the inspection target apparatus, outputs the converted signal to the inspection target apparatus 10, acquires response data of the inspection target apparatus 10 obtained according to the converted signal, and calculates a degree of matching of the response data with an expected operation or an expected data included in the apparatus specification information or an inspection scenario including the processing, and the expected operation or the expected data of the inspection target apparatus.

### CROSS-REFERENCE TO RELATED APPLICATIONS

This application is a bypass continuation-in-part of PCT Application No. PCT/JP2018/012371, filed Mar. 27, 2018, which claims the benefit of Japanese Patent Application No. JP2017-092917, filed May 9, 2017. The entire contents of the above-identified applications are hereby incorporated by reference herein.

### TECHNICAL FIELD

The present disclosure mainly relates to an automatic inspecting device which automatically inspects an inspection target apparatus.

### BACKGROUND ART

Patent Document 1 discloses a technology in which image data of a printed matter printed by a printer etc. is acquired, and the printer etc. is inspected based on the quality of the image data.

Patent Document 2 discloses a technology in which two image data are acquired, and a difference between the two images is detected by comparing the image data.

### REFERENCE DOCUMENTS OF CONVENTIONAL ART

### Patent Documents

### [Patent Document 1] JP4006224B2

### [Patent Document 2] JP2013-214178A

### DESCRIPTION OF THE DISCLOSURE

### Problems to be Solved by the Disclosure

The conventional automatic inspecting devices conduct the inspection along an inspection scenario indicative of a procedure of the inspection. The conventional inspection scenario is expressed by an operation series of buttons or a keyboard which is operated concretely by a human. Therefore, in the conventional automatic inspecting device, when apparatus specification information indicative of specification of an inspection target apparatus is changed, it is necessary to change the inspection scenario according to the change. Since this processing may become complicated and the frequency of the processing may be high, an improvement thereof is demanded because the processing takes time and effort for an operator.

The present disclosure is made in view of the above situations, and a main purpose thereof is to provide an automatic inspecting device in which a change in an inspection scenario is unnecessary or little, even if an apparatus specification information is changed.

### SUMMARY OF THE DISCLOSURE

The problem to be solved by the present disclosure is as described above, and means to solve the problem is described below.

According to one aspect of the present disclosure an automatic inspecting device with the following configuration is provided. That is, this automatic inspecting device includes a hardware processor. The hardware processor converts processing to be performed by an inspection target apparatus into a converted signal corresponding to apparatus specification information on the inspection target apparatus, outputs the converted signal to the inspection target apparatus, acquires response data of the inspection target apparatus obtained according to the converted signal, and calculates a degree of matching of the response data with an expected operation or an expected data included in the apparatus specification information or an inspection scenario including the processing, and the expected operation or the expected data of the inspection target apparatus.

According to this, since the automatic inspecting device has the function to convert the processing to be performed by the inspection target apparatus into the converted signal, the inspection scenario can be described using the processing to be performed by the inspection target apparatus. Therefore, even if the apparatus specification information is changed, since it is not necessary to change the inspection scenario accordingly, the operator's burden can be reduced significantly.

### BRIEF DESCRIPTION OF DRAWINGS

FIG. 1 is a block diagram illustrating configurations of an inspection target apparatus and an automatic inspecting device.

FIG. 2 is a view illustrating contents of data stored in a memory of the automatic inspecting device.

FIG. 3 is a flowchart illustrating contents of a dummy inspection.

FIG. 4 is a flowchart illustrating processing to edit apparatus specification information created by the dummy inspection.

FIG. 5 is a flowchart illustrating contents of a font learning.

FIG. 6 is a flowchart illustrating contents of a menu search which is a type of the dummy inspection based on an operational tip.

FIG. 7 is a flowchart illustrating contents of a screen search which is a type of the dummy inspection based on the operational tip.

FIG. 8 is a flowchart illustrating contents of an automatic inspection.

FIG. 9 is a flowchart illustrating processing from a command output to the next command output.

FIG. 10 is a flowchart illustrating an off-line inspection.

### DETAILED DESCRIPTION

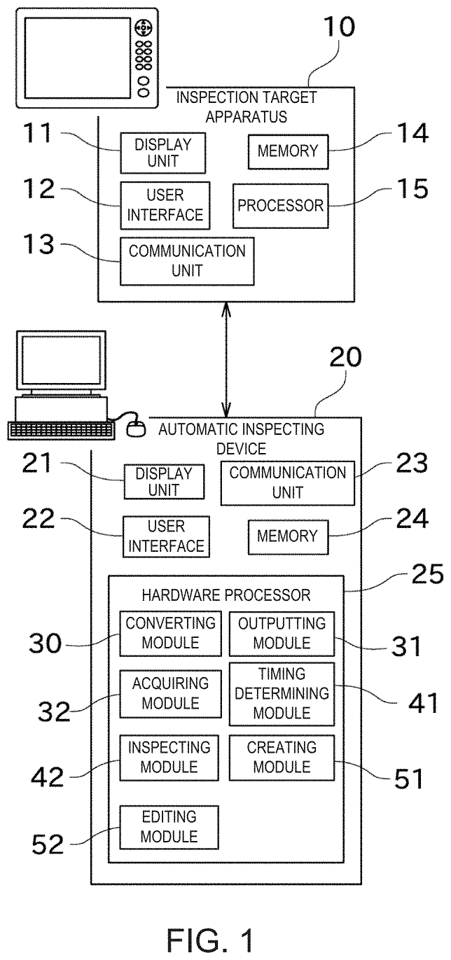

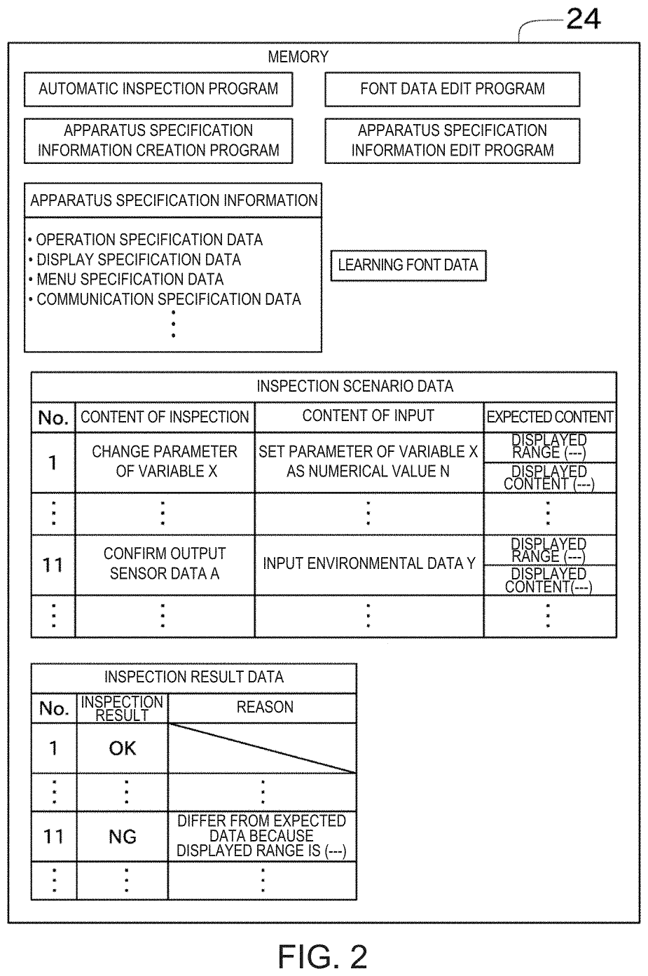

Next, one embodiment of the present disclosure is described with reference to the drawings. Referring first to FIG. 1, configurations of an inspection target apparatus 10 and an automatic inspecting device 20 are described. FIG. 1 is a block diagram illustrating the configurations of the inspection target apparatus 10 and the automatic inspecting device 20. FIG. 2 is a view illustrating contents of data stored in a memory 24 of the automatic inspecting device 20.

The automatic inspection device may be a device which automatically inspects whether the inspection target apparatus 10 operates as a specification defined beforehand. “The automatically inspect” may mean that, while instructing to the inspection target apparatus 10 using a computer, the computer calculates a determination of acceptance (success or failure) or a score value of response data from the inspection target apparatus 10 according to the instruction, and records the success or failure or the score value.

The inspection target apparatus 10 may have a particular usage, and may be a built-in apparatus having a function specialized in this usage (e.g., a ship apparatus, a measurement apparatus, a medical device, a communication apparatus, or a transportation apparatus). Note that the inspection target apparatus 10 may be configured so that a given application is installed in a general-purpose computer. If using the general-purpose computer as the inspection target apparatus 10, the general-purpose computer itself can become a subject of the inspection, or the installed application can also become the subject of the inspection.

The inspection target apparatus 10 may include a display unit 11, a user interface 12, a communication unit 13, a memory 14, and a processor 15. The display unit 11 may be a part which displays given information, and is a liquid crystal display, for example. The user interface 12 may be a part which is operated by a user to give a given instruction to the inspection target apparatus 10, and is a keyboard, a pointing device, a touch panel, or a voice recognizer, for example. The communication unit 13 may be a part used for the inspection target apparatus 10 communicating with other apparatuses (especially, the automatic inspecting device 20), such as a communication antenna and a connection of a telecommunication cable. The memory 14 may be a part to store electronic data. The processor 15 may be a part to perform calculation using a given program.

The automatic inspecting device 20 may be device to automatically inspect the inspection target apparatus 10. The automatic inspecting device 20 may be configured so that an application for the automatic inspection is installed in the general-purpose computer (an automatic inspection program is stored). Note that the automatic inspecting device 20 may be a built-in apparatus of which the main usage is the automatic inspection.

The automatic inspecting device 20 may include a display unit 21, a user interface 22, a communication unit 23, the memory 24, and a processor 25 (which may also be referred to as a hardware processor). The display unit 21 may be a liquid crystal display which displays given information. The user interface 22 may be a part which is operated by a user to give a given instruction to the automatic inspecting device 20, and is a keyboard, a pointing device, a touch panel, or a voice recognizer, for example. The communication unit 23 may be a part used for the automatic inspecting device 20 communicating with other apparatuses (especially, the inspection target apparatus 10), such as a communications antenna and a connection of a telecommunication cable.

The memory 24 may be a nonvolatile memory which can store electronic data, in detail, a flash memory (a flash disc, a memory card, etc.), a hard disk drive, or an optical disc. As illustrated in FIG. 2, the memory 24 may store the automatic inspection program, an apparatus specification information creation program, an apparatus specification information edit program, a font data edit program, apparatus specification information, learning font data, inspection scenario data, and inspection result data. Note that some of these data (especially, the apparatus specification information, the inspection scenario data, and the inspection result data) may be stored in a device other than the automatic inspecting device 20.

The automatic inspection program may be a program for executing the automatic inspection described above. The apparatus specification information creation program may be a program for creating apparatus specification information by using the response data from the inspection target apparatus 10. The apparatus specification information edit program may be a program for editing the apparatus specification information created using the apparatus specification information creation program, based on operation and permission by the operator. The font data edit program may be a program for editing the learning font data (described later).

The apparatus specification information may be data describing contents of the design, the agreement, the requirements, etc. of the inspection target apparatus 10. The apparatus specification information includes, for example, operation specification data, display specification data, menu specification data, and communication specification data. The operation specification data may describe what type of processing the inspection target apparatus 10 performs when the user interface 12 is operated. The display specification data may describe what type of screen is displayed on the display unit 11 of the inspection target apparatus 10. In more detail, it may be the types of the screen displayed by the inspection target apparatus 10 (an initial setting screen, a menu selection screen, a display screen of a measurement result, etc.), and contents of the information displayed in the screen, a display range of the information, a size, a font (in case of character(s)), etc. The menu specification data may be data indicative of a menu tree of the inspection target apparatus 10 (data indicative of contents of menu items, a display order, a hierarchy, etc.), a menu title, etc. The communication specification data may be a telecommunications standard which is used by the inspection target apparatus 10 for communicating with other apparatuses. Moreover, these specification data may include data indicative of the present setting of a given setting item.

The inspection scenario data may be data for defining what type of processing the inspection target apparatus 10 is made to perform during the automatic inspection. The inspection scenario may include a plurality of inspecting items. The inspecting item may be a hierarchization of the inspection scenario according to content of the inspection. As illustrated in FIG. 2, each inspecting item may describe an inspection number (numerical position), the content of the inspection, content of an input, expected content. The inspection number may have a function as an ID of the inspecting item (the ID may be set separately), while illustrating an order of inspections. The content of the inspection may describe what type of content is inspected. The content of the input may describe what type of instruction is inputted into the inspection target apparatus 10 by the user's intention level (i.e., describes the operational intention of the user). Moreover, the content of the input may describe environmental data provided from an external apparatus, instead of or in addition to the operational intention. The expected content may include expected data and an expected operation. The expected data may be data which is derived from the apparatus specification information and the inspection scenario and outputted from the inspection target apparatus 10. The expected operation may be an operation of the inspection target apparatus 10 derived from the apparatus specification information and the inspection scenario. Note that the expected content may include a display range (a rectangular area indicated by four pixel addresses e.g., including the position and the size) of the information displayed on the display unit 11, a range of a numerical value displayed, a relation of magnitude between the numerical value displayed and other data, a temporal characteristic of the numerical value, content of the character displayed, a time order with other events, and a delay time. Note that the expected content may be described in the apparatus specification information, in addition to or instead of the inspection scenario data.

The learning font data may be data for performing a character recognition (OCR) for the character displayed on the display unit 11 of the inspection target apparatus 10 (will be described later for details).

The inspection result data may be data indicative of a result of the inspection conducted using the inspection scenario. The automatic inspecting device 20 may automatically perform the inspection by comparing the expected data or the expected operation of the inspection scenario with data actually outputted from the inspection target apparatus 10 (hereinafter, referred to as the “response data”). In detail, if the expected content is comprised of a single numerical value, the determination result may become “OK” when the expected data matches with the response data of the inspection target apparatus 10. If the expected content is comprised of a numerical range, the determination result may become “OK” when the response data falls within this range. Moreover, if the expected content is a monotonic increase or a convergence, the determination result may become “OK” when the inspection target apparatus 10 demonstrates such a behavior. On the other hand, when the response data described above is not obtained, the determination result may become “NG.” If the determination result is “NG,” the reason of becoming “NG” (a ground of the determination), i.e., what is the difference between the expected content and the response data of the inspection target apparatus 10, may be described. Moreover, as the inspection result data, a score value may also be described, in addition to “OK” and “NG.” For example, the score value is calculated according to the difference etc. between the value of the response data and the value of expected content, and the score value may be described as the inspection result data.

The processor 25 may be implemented by an arithmetic unit, such as a FPGA, an ASIC, or a CPU. The processor 25 may be configured to execute various processings for the automatic inspecting device 20 by executing program(s) created beforehand (e.g., the automatic inspection program and/or the apparatus specification information creation program). In the following description, although automatic inspection and apparatus specification information creation are described in detail among the processings executed by the processor 25, the processor 25 can also execute other processings.

The processor 25 may include a converting module 30, an outputting module 31, an acquiring module 32, a timing determining module 41, an inspecting module 42, a creating module 51, and an editing module 52.

The converting module 30 may read the inspection scenario, and perform a calculation to convert the operational intention of the user or the environmental data provided from the external apparatus, which are described in the inspection scenario, into an operation signal or input sensor data for the inspection target apparatus 10 (these are comprehensively referred to as the “converted signal”) based on the apparatus specification information on the inspection target apparatus 10. In detail, for example, if the inspection target apparatus 10 is a sonar, suppose that “a transmission frequency of a sound wave shall be 200 kHz” is described as the user's operational intention. The converting module 30 may convert the operational intention into the operation signal of the user interface 12 required for reading a screen where a transmission frequency of the sound wave is set and selecting 200 kHz. Note that the converting module 30 may perform the conversion based on the apparatus specification information on the inspection target apparatus 10 (in more detail, the operation specification data). Moreover, a conversion of the environmental data is described as another example. For example, if the inspection target apparatus 10 communicates with the external sensor by using LAN etc., it is necessary to convert a detection value of the external sensor into sentence format data from data indicative of physical quantity. The converting module 30 may perform the conversion based on the apparatus specification information (in detail, the communication specification data). Moreover, if the inspection target apparatus 10 communicates with an external sensor through an analog interface, a program for processing data from the external sensor is needed at the inspection target apparatus 10 end. Therefore, the converting module 30 may convert the environmental data using protocols, such as a format and timing according to the program. This conversion may be also performed based on the apparatus specification information (in detail, the communication specification data), similar to the above. Thus, the data obtained by converting the environmental data into the form which can be processed by the inspection target apparatus 10 based on the apparatus specification information may be referred to as the “input sensor data.”

The outputting module 31 may perform both of operation signal output and sensor data output (the outputting module 31 may perform only one of the processings). The operation signal output may be processing to output the operation signal which realizes a state where the user interface 12 of the inspection target apparatus 10 is operated (the operation signal created by the converting module 30). In this embodiment, the state where each key of the user interface 12 is operated may be realized by the outputting module 31 outputting the operation signal to the inspection target apparatus 10. Therefore, the outputting module 31 may be possible to output the operation signal according to the number of keys of the user interface 12, a method of operating the key(s), etc. Note that the outputting module 31 may be configured so that it outputs the operation signal for physically operating the user interface 12 of the inspection target apparatus 10 (press, rotation, etc. of the key). In this case, an operation mechanism for physically operating the user interface 12 may be provided near the user interface 12, and the state may be realized where, by the outputting module 31 outputting a given operation signal to the operation mechanism, the operation mechanism operates the user interface 12 so that each key of the user interface 12 is operated. The sensor data output may be processing to output the output sensor data indicative of the detection result of the given sensor to the inspection target apparatus 10 (the output sensor data created by the converting module 30). Note that processing including at least one of the operation signal output and the sensor data output may be referred to as a “command output.”

The acquiring module 32 may acquire the response data outputted from the inspection target apparatus 10 according to content of the output from the outputting module 31. The data acquired by the acquiring module 32 may be image data of the screen displayed on the display unit 11 of the inspection target apparatus 10, or may be character data or numerical data displayed on the display unit 11, or may be data outputted to the external apparatus from the inspection target apparatus 10 (image data, character data, numerical data, etc.). Moreover, when acquiring the image data of the screen displayed on the display unit 11 (hereinafter, referred to as “acquiring the screen etc.”), the acquiring module 32 may acquire the screen by communicating with the inspection target apparatus 10, or may acquire the screen by imaging the display unit 11 by a camera etc.

The timing determining module 41 may determine the timing at which the outputting module 31 outputs the operation signal or the sensor data. The inspecting module 42 may calculate a degree of matching of the expected data of the inspection scenario with the response data of the inspection target apparatus 10. In detail, the inspecting module 42 may inspect whether the degree of matching of the expected data with the response data is within a given range (passed or not), or calculate the score value based on the degree of matching of the expected data with the response data.

The creating module 51 may create the apparatus specification information (e.g., by analyzing the acquired screen etc.) based on the response data acquired by the acquiring module 32, or edit the apparatus specification information based on an instruction from the operator. The editing module 52 may edit the learning font data.

Here, the purpose of creating the apparatus specification information based on the response data outputted from the inspection target apparatus 10 may be described. Conventionally, the apparatus specification information may be mainly created by a manual input. Since the matters defined by the apparatus specification information are enormous, the creation of the apparatus specification information may take a long period of time, and an error may be included in the created apparatus specification information. If an error is included in the apparatus specification information, even when the inspection target apparatus 10 operates normally, since the apparatus specification information is old, the expected data may become an incorrect value, and, therefore, the inspection result may become “NG.” In consideration of such a situation, in order to create the apparatus specification information easily and accurately, the automatic inspecting device 20 of this embodiment may perform processing to automatically create the apparatus specification information based on the response data of the inspection target apparatus 10 (a dummy inspection, a menu search, a screen search). This is described concretely below.

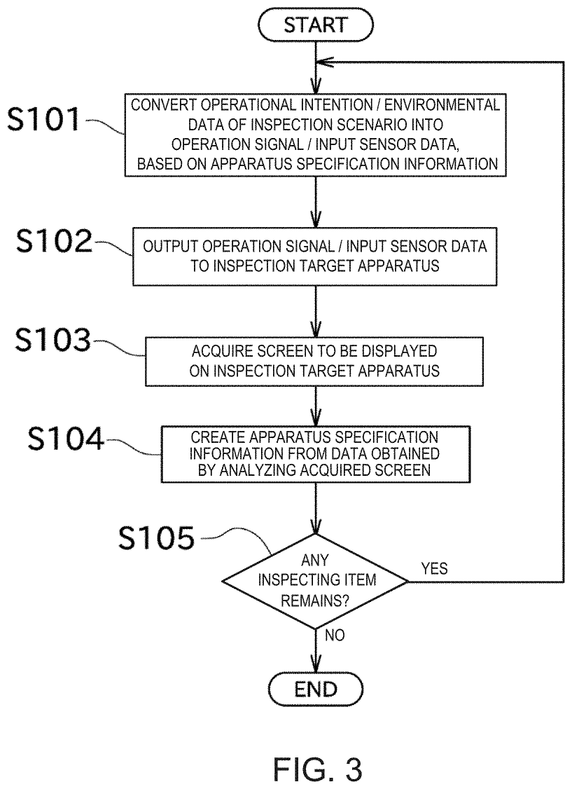

First, referring to FIG. 3, the dummy inspection in which the apparatus specification information is created is described. FIG. 3 is a flowchart illustrating contents of the dummy inspection.

The dummy inspection may aim at acquiring the display specification of the inspection target apparatus 10 by changing the screen of the inspection target apparatus 10 along the inspection scenario. That is, this processing may be referred to as the “dummy” inspection because it performs processing similar to the inspection without aiming at acquiring the inspection result. Note that the automatic inspecting device 20 may be configured to acquire the response data other than the screen.

First, as described above, the automatic inspecting device 20 (converting module 30) may read the inspection scenario, and convert the user's operational intention or the environmental data provided from the external apparatus, which are described in the inspection scenario, into the operation signal/the input sensor data for the inspection target apparatus 10 based on the apparatus specification information on the inspection target apparatus 10 (S101). Thus, in the following, at least one of the operation signal and the sensor data (i.e., the converted signal) may be referred to as the “operation signal/sensor data” using a slash. Next, the automatic inspecting device 20 (outputting module 31) may output the operation signal/sensor data to the inspection target apparatus 10 based on the inspection scenario (S102). The screen of the inspection target apparatus 10 may be changed by Step S102.

Next, the automatic inspecting device 20 (acquiring module 32) may acquire the screen (display screen) to be displayed on the inspection target apparatus 10 (S103). In the inspection based on the inspection scenario, the screen to be displayed on the inspection target apparatus 10 may be acquired after performing a series of operations and data input based on the operational intention. That is, only the screen to be used for the inspection may be acquired in the inspection based on the inspection scenario. Note that, instead of this processing, processing to acquire all the screens may be performed during the inspection based on the inspection scenario.

Next, the automatic inspecting device 20 (creating module 51) may create the apparatus specification information from the data obtained by analyzing the screen acquired at Step S103 (S104). The analysis of the screen may be processing to extract data included in the screen by performing a character recognition, a pattern recognition, etc. to the screen. The data included in the screen may include a type of data displayed and its display range (position and size), a code indicative of a concrete character, a symbol, a number, etc. displayed, and a size, a color, a font, etc. of the character. These data may be the apparatus specification information (especially, the display specification data) itself, or become original data from which the apparatus specification information is created. Therefore, the apparatus specification information can be created based on the data obtained by analyzing the screen.

Next, the automatic inspecting device 20 may determine whether any inspecting item remains (S105). If the inspecting item remains (the inspection scenario has not been finished), the automatic inspecting device 20 may return to Step S101, where the next operation signal/sensor data is converted (S101). On the other hand, if the inspecting item does not remain (the inspection scenario has been finished), the automatic inspecting device 20 may end the dummy inspection.

Thus, by performing the dummy inspection, the screen to be displayed can be acquired based on the inspection scenario. In the inspection scenario, since it is thought that a screen of all states (especially, an important screen) is displayed, the screen created by the inspection target apparatus 10 can comprehensively be acquired. By creating the apparatus specification information using the computer as described above, the apparatus specification information can be created easily within a short period of time, as compared with the case where it is created manually. Further, since a human error can be prevented, accurate apparatus specification information can be created. Note that in order for cases, such as the correct specification being not reflected on the inspection target apparatus 10 or the inspection scenario having an error, the automatic inspecting device 20 may have a function to edit the apparatus specification information created as described above. Below, this is described concretely.

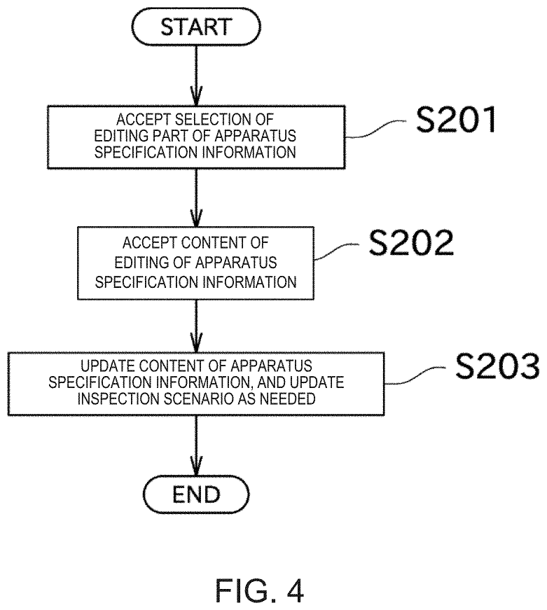

Next, processing to edit the apparatus specification information acquired by the dummy inspection is described with reference to FIG. 4. FIG. 4 is a flowchart illustrating the processing to edit the apparatus specification information based on the result of the dummy inspection.

The operator may perform a suitable operation to the user interface 22 of the automatic inspecting device 20 to be able to make the apparatus specification information created by the automatic inspecting device 20 display on the display unit 21. Moreover, the automatic inspecting device 20 may accept a selection of editing part of the apparatus specification information based on an instruction from the operator (S201), accept content of the change of the editing part (S202), and update content of the apparatus specification information (S203). Note that, when the content updated here also influences content of the inspection scenario, the automatic inspecting device 20 may also update the inspection scenario based on the content of the update (S203). For example, when the display range of the character is updated, the display range of the character described in the inspection scenario (a range where the character recognition is performed) may be also updated.

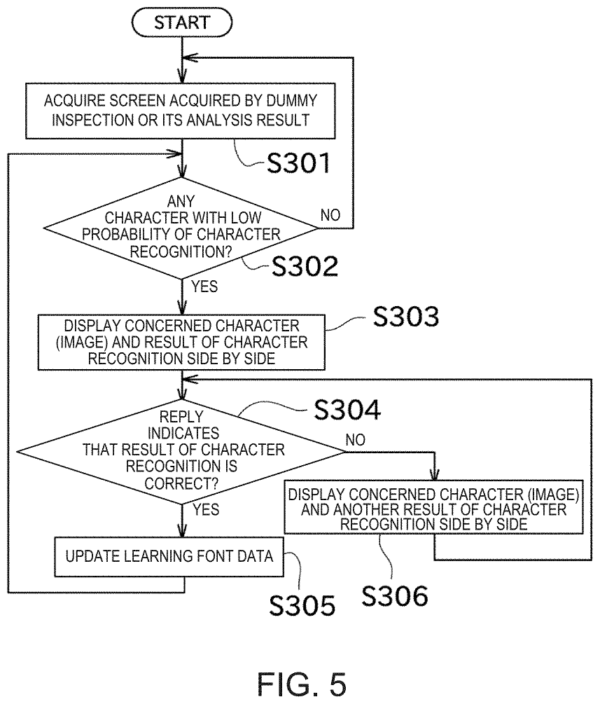

Next, the font learning is described with reference to FIG. 5. FIG. 5 is a flowchart illustrating contents of the font learning.

The automatic inspecting device 20 may perform a learning of the font data of the inspection target apparatus 10 beforehand to create the learning font data. The learning font data may be data indicative of a correspondence between the character code and an image of the character. The automatic inspecting device 20 may acquire the font data used by the inspection target apparatus 10 in advance from the inspection target apparatus 10 or another source. Therefore, since the automatic inspecting device 20 uses the font data used by the inspection target apparatus 10, it can perform a highly-accurate character recognition (OCR). However, since gradations of color may be applied and displayed, or antialiasing may be performed when displaying the character etc. depending on the inspection target apparatus 10, the character recognition may be failed. In this embodiment, in order to perform the character recognition more correctly, the following font learning may be performed to update the learning font data.

First, the automatic inspecting device 20 (outputting module 31) may acquire the screen acquired by the dummy inspection, or its analysis result (the result of the character recognition) (S301). Then, if the screen acquired by the dummy inspection is acquired, the automatic inspecting device 20 may perform the character recognition for the screen. The data used here for the character recognition may be font data learned in advance. That is, the character recognition may be performed (or acquiring a result of the character recognition) by obtaining a degree of matching of the image of the character included in the screen acquired at Step S301 with the image of the character learned in advance.

Next, the automatic inspecting device 20 may determine whether there is any low probability of the character recognition as a result of the character recognition (S302). This processing can be determined based on whether the degree of matching is lower than a given threshold.

If there is no low probability of the character recognition, the automatic inspecting device 20 may return to Step S301, where another screen is acquired (S301). If there is a low probability of the character recognition, the automatic inspecting device 20 may display the image of the character concerned (a part of the screen acquired at Step S301) and the character of which the degree of matching is the highest in the character recognition on the display unit 21 side by side (S303) to inquire the operator whether the character recognition is correct.

The automatic inspecting device 20 may wait for a reply from the operator of whether the result of the character recognition is correct (S304). If there is a reply from the operator indicating that the result of the character recognition is correct, the automatic inspecting device 20 (editing module 52) may update the learning font data (S305). In detail, content of the learning font data may be changed so as to associate the image of the character included in the screen acquired at Step S301 with the character code. Therefore, the character recognition can be performed more accurately.

Moreover, if there is a reply from the operator indicating that the result of the character recognition is not correct (in case of No at Step S304), the automatic inspecting device 20 may display the character with the second highest degree of matching image and the image of the character included in the screen side by side to similarly inquire (S306). Note that an input of a correct character may be accepted from the operator.

Moreover, the learning of the font performed in advance may be omitted. In this case, the automatic inspecting device 201 may perform the font learning on the basis of common character recognition software, without acquiring the font data used by the inspection target apparatus 10. Therefore, although the number of updates of the learning font data increases, prior processing may become easier.

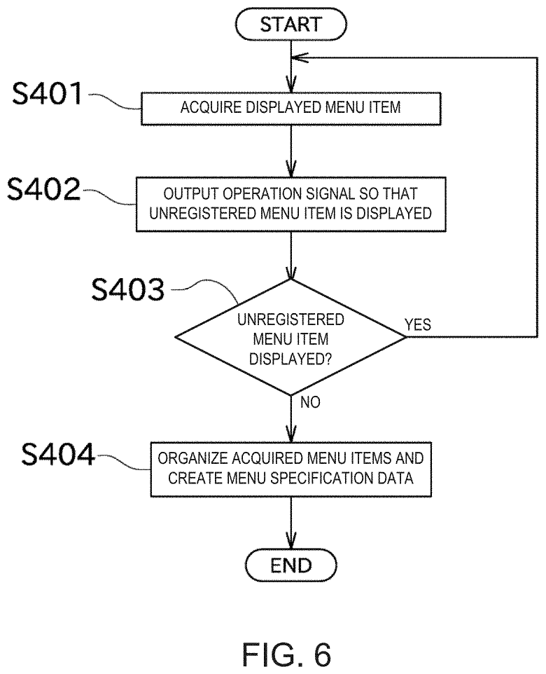

Next, the menu search based on an operational tip is described with reference to FIG. 6. FIG. 6 is a flowchart illustrating contents of the menu search. In the processing of FIG. 6, the operational tips may be fundamental information on operation or display of the menu items (an operation to open the menu panel, an operation to move a selecting position of the menu item, a determining operation, an operation to cancel the determination, etc.).

In the general inspection scenario, operations related to the target inspecting items may be performed by combining single operation signals. However, if the menu tree (the menu items are arranged based on the hierarchy) changes, it is necessary to correct the inspection scenario even if the same menu item is to be selected because the combination of the operation signals may differ. Moreover, since it is necessary to describe a plurality of operations when creating the inspection scenario with new inspecting items, the operator's burden may be large. In this embodiment, in order to reduce such a burden, the following menu search is performed.

The menu search may be that the automatic inspecting device 20 operates the inspection target apparatus 10 based on the operational tip, without depending on the inspection scenario, to acquire the menu tree of the inspection target apparatus 10. Therefore, the operation signal outputted during the menu search may be not the operation signal obtained by converting the user's operational intention etc. (converted signal), but an operation signal which is autonomously generated by the automatic inspecting device 20. The menu search may be an inspection without aiming at a creation of the inspection result data. By acquiring the menu tree, it can easily obtain what type of operation should be carried out (what type of operation signal should be outputted) in order to select a given menu item (the operational intention, the operation purpose). Below, this is described concretely.

First, the automatic inspecting device 20 may be caused to learn the operational tip. Based on this learning, the automatic inspecting device 20 may output the operation signal, and search for the menu item.

In detail, the automatic inspecting device 20 (acquiring module 32) may acquire and analyze (the character recognition etc.) the screen displayed on the inspection target apparatus 10 to acquire the menu item displayed on this screen (S401). Next, the automatic inspecting device 20 (outputting module 31) may output the operation signal so that an unregistered menu item is displayed (S402). In detail, it may select a menu item which is a menu item displayed on the screen and has not been selected yet by the menu search. Alternatively, it may display higher order menu items than the present menu items, and select a menu item which has not been selected yet by the menu search among the higher order menu items.

Then, the automatic inspecting device 20 may determine whether the unregistered menu item is displayed (S403). If the unregistered menu item is displayed, it may return to Step S401 where the unregistered menu item displayed is acquired. Moreover, if unregistered menu item is not displayed even after the processing at Step S402 is performed, the automatic inspecting device 20 may determine that the search of all the menu items is finished, and organize the acquired menu items and create the menu specification data which is a type of the operation specification data (the menu tree, the menu title, the setting value, etc.) (S404).

Note that, as illustrated in FIG. 4, the automatic inspecting device 20 (creating module 51) can also change (edit) the contents of the menu specification data created as described above based on an instruction from the operator.

Thus, by creating the menu specification data based on the menu items obtained by operating the inspection target apparatus 10, the menu specification data which the inspection target apparatus 10 has can be created easily and accurately.

Moreover, by creating the menu specification data, it can easily obtain what type of operation signal should be outputted in order to input a value into given information or to select the value. Thus, only a variable and a parameter to be selected finally may be described in the inspection scenario. Below, this is described concretely. In this embodiment, as illustrated by No. 1 of the inspection scenario of FIG. 2, “Parameter of variable X is set as numerical value N” is described as the inputted content. For example, if the inspection target apparatus 10 is a sonar, the inputted content includes setting of the transmission frequency of the sound wave as 200 kHz, for example. Here, in the conventional automatic inspecting device, when setting such an inputted content, an operating procedure (a sequence of key codes) required for changing the parameter of the variable X may be described in the inspection scenario. Therefore, in the conventional automatic inspecting device, when the menu specification data of the menu tree etc. is changed, it is necessary to change the inspection scenario. On the other hand, in this embodiment, it may be configured so that the inspection scenario is described in the operational intention, and the operational intention is converted into the key code etc. based on the apparatus specification information (specifically, the menu specification data). Therefore, in the automatic inspecting device 20 of this embodiment, even if the menu specification data of the menu tree etc. is changed, the change of the inspection scenario is unnecessary.

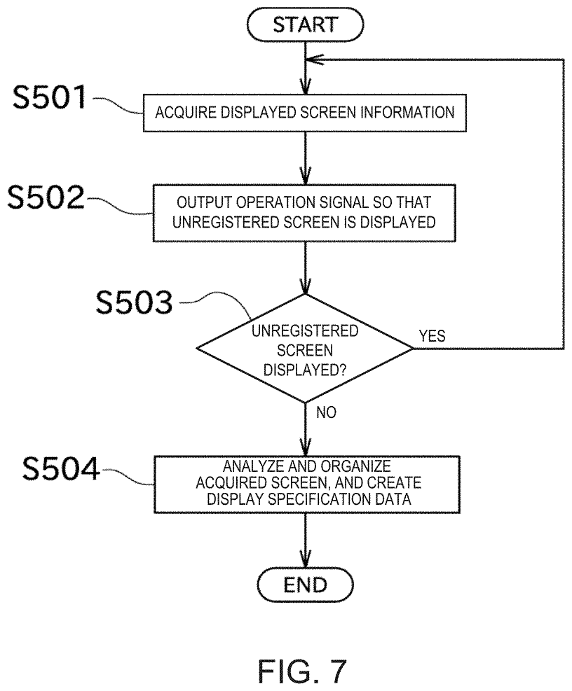

Next, the screen search based on the operational tip is described with reference to FIG. 7. FIG. 7 is a flowchart illustrating contents of the screen search. In the processing of FIG. 7, the operational tip may be fundamental information on operation or display related to a screen selection (an operation to open a screen, an operation to switch the screen, etc.).

The screen search may be processing aiming at updating the display specification data based on the screen acquired from the inspection target apparatus 10. The screen search may be an inspection without aiming at an acquisition of the inspection result data. Since the screen search is similar processing to the menu search, it is described briefly.

First, the automatic inspecting device 20 may be caused to learn the operational tip. Based on this learning, the automatic inspecting device 20 may output the operation signal to search for the screen.

In detail, the automatic inspecting device 20 (acquiring module 32) may acquire and analyze the screen displayed on the inspection target apparatus 10 to acquire the type of screen and the information displayed on the screen (S501). The information displayed on the screen may include the type of information displayed and its display range (position and size), the code indicating the concrete character, symbol, number, etc. displayed, and the size, color, font of the character etc. Next, the automatic inspecting device 20 (outputting module 31) may output the operation signal so that an unregistered screen is displayed (S502). Then, the automatic inspecting device 20 may determine whether the unregistered screen is displayed (S503). When the unregistered screen is displayed, it may return to Step S501 where the unregistered screen displayed is acquired. Moreover, if the unregistered screen is not displayed, even when performing the processing at Step S502, the automatic inspecting device 20 may determine that the search of all the screens is finished, and analyze and organize the acquired screen to create the screen data (S504).

Note that, as illustrated in FIG. 4, the automatic inspecting device 20 (creating module 51) can also change (edit) the contents of the screen data created as described above based on an instruction from the operator.

Moreover, the menu search and the screen search also may have the following usage and advantages. That is, these processings can be used for inspecting whether the inspection target apparatus 10 of a new version matches with the specification data of a former version. Since this confirmation does not require the inspection scenario, it can be performed more easily (without the operator's burden). Moreover, the data obtained by these processings (especially, the menu search) can also be used as a database for converting the operational intention of the inspection scenario into the operation command. Moreover, the data obtained by these processings (especially, the screen search) can also be used as a database for describing the display range of the information in each screen displayed on the inspection target apparatus in the inspection scenario or the apparatus specification information.

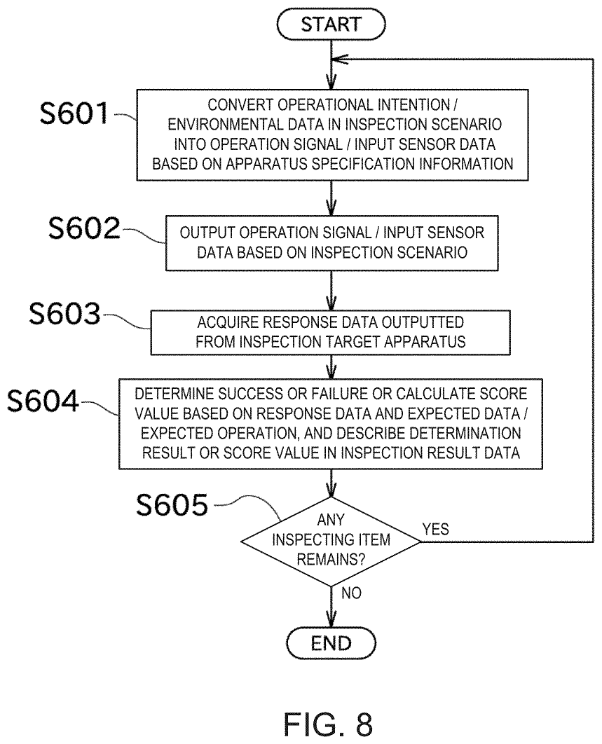

Next, the automatic inspection is described with reference to FIG. 8. FIG. 8 is a flowchart illustrating contents of the automatic inspection.

First, the automatic inspecting device 20 (converting module 30) may read the inspection scenario similar to the dummy inspection, and convert the user's operational intention or the environmental data provided from the external apparatus described in the inspection scenario into the operation signal/the input sensor data for the inspection target apparatus 10 based on the apparatus specification information on the inspection target apparatus 10 (S601).

Next, the automatic inspecting device 20 (outputting module 31) may output the operation signal/sensor data converted at Step S101 (S602). Next, the automatic inspecting device 20 may acquire the response data from the inspection target apparatus 10 (S603). Note that the response data acquired here may be a screen displayed on the inspection target apparatus 10 according to the operation signal/input sensor data, or output sensor data outputted from the inspection target apparatus 10 according to the operation signal/input sensor data.

Next, the automatic inspecting device 20 (inspecting module 42) may determine the acceptance (success or failure) based on the response data and the expected data/expected operation, or calculate the score value (i.e., calculate the degree of matching), and describe the determination result or the score value in the inspection result data (S604). As described above, when the success or failure of the response data is determined, “OK” or “NG” may be described, and when the score value of the response data is calculated, this value may be described. Moreover, the ground of the determination when the determination result is “NG;” or the ground when the score value is below the given threshold may be also described in the inspection result data.

Next, the automatic inspecting device 20 may determine whether any inspecting item remains (S605). If any inspecting item remains (the inspection scenario has not been finished), the automatic inspecting device 20 may return to Step S601 where the operation signal/sensor data is converted for the next inspecting item. On the other hand, if no inspecting item remains (the inspection scenario has been finished), the automatic inspecting device 20 may end the automatic inspection.

Note that the automatic inspecting device 20 may store the response data of the inspection target apparatus 10 (the screen displayed on the inspection target apparatus 10) acquired at Step S603 in the memory 24, similar to the dummy inspection. The stored response data can be used for an off-line inspection described later.

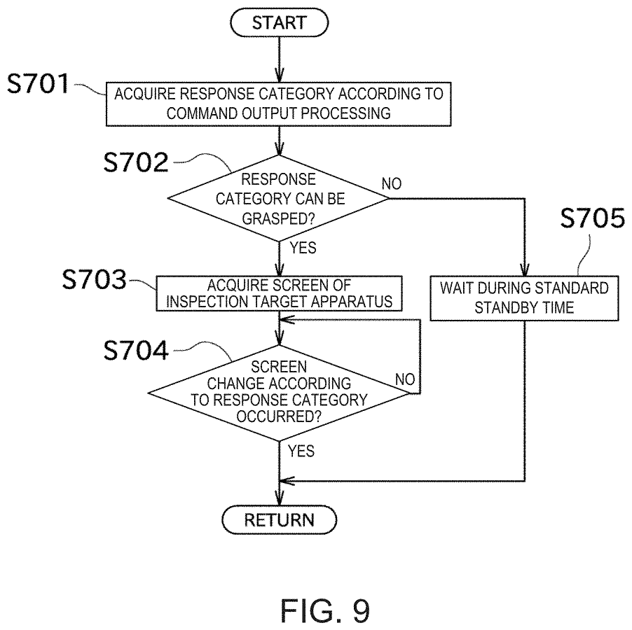

Next, processing to determine the output timing is described with reference to FIG. 9. FIG. 9 is a flowchart illustrating the processing after the command output and before the next command output.

Here, when the command output is continuously performed to the inspection target apparatus 10, if a second command output is performed before the processing performed by the inspection target apparatus 10 for a first command output is finished (for example, in a state where the screen has not been changed yet though the operation signal to instruct the screen change is outputted), the second command output may not be accepted. Therefore, generally, a standard standby time which is a period of time until accepting the next command output may be set, and the next command output may be set to be performed after the standard standby time is lapsed. Note that, in order to ensure the automatic inspection, the standard standby time may be set as a value with a given margin (a longer estimated value). Therefore, the time required for the automatic inspection may be long. In consideration of this situation, in this embodiment, it may be configured so that a state of the inspection target apparatus 10 is detected based on the change in the screen of the inspection target apparatus 10, and the next command output is performed.

The processing illustrated in FIG. 9 may be performed between a certain command output and the next command output in case of Step S601 of FIG. 8 including a plurality of command outputs. First, the automatic inspecting device 20 may acquire a response category of the last command output (S701). The response category may be a classification by type of the response operation performed by the inspection target apparatus 10 to the command output. Although a way to classify the response category is arbitrary, it may include a cursor movement, a screen change, a numerical value display, etc.

If the response category to the latest command output can be grasped, the automatic inspecting device 20 may acquire the screen of the inspection target apparatus 10 (S703), and analyze this screen to detect whether the screen change according to the response category is occurred (S704). If the screen change according to the response category is occurred (e.g., if the response category is the screen change and the screen changed can be recognized), since it can be determined that the processing of the inspection target apparatus 10 for the latest command output is finished, the processing of FIG. 9 may be ended. Then, the timing determining module 41 may instruct the outputting module 31 to perform the next command output. Thus, since the period of time between a command output and the next command output can be shortened, the period of time required for the automatic inspection can be shortened.

Note that, at Step S702, if the response category cannot be grasped, the automatic inspecting device 20 may wait during the standard standby time (S705). After this standby time, the timing determining module 41 may instruct the outputting module 31 to perform the next command output.

Note that, the automatic inspecting device 20 may detect that the inspection target apparatus 10 accepts the command output from the outputting module 31 based on generated sound or the sentence output from the inspection target apparatus 10, without limiting to the screen change.

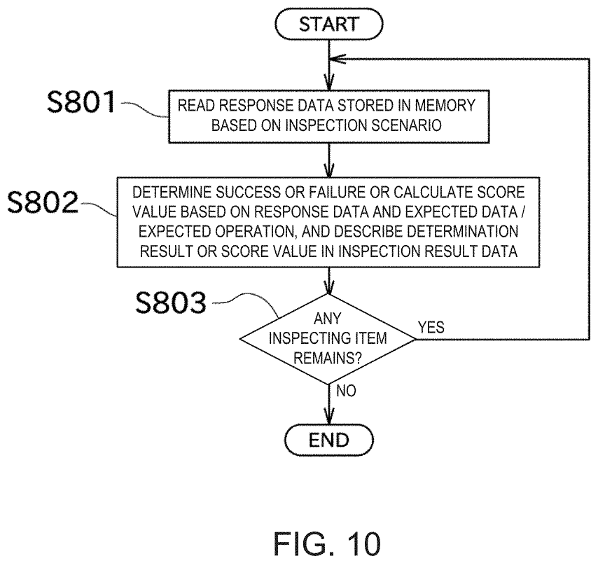

Next, the off-line inspection is described with reference to FIG. 10. FIG. 10 is a flowchart illustrating the off-line inspection.

The automatic inspecting device 20 of this embodiment may perform the dummy inspection or the automatic inspection, and store in the memory 24 the screen to be displayed by the inspection target apparatus 10 for every inspecting item of the inspection scenario. Therefore, for example, when the automatic inspection is performed and there is an inspecting item for which the inspection result is “NG,” a reinspection can be performed using the screen stored in the memory 24.

Note that, if a fault etc. is occurred in the inspection target apparatus 10 during the automatic inspection conducted first and an error exists in the obtained image itself, it may not be appropriate to perform the off-line inspection. The off-line inspection may be suitable to perform for confirming that the inspection result becomes correct after a correction of the apparatus specification information etc. when the inspection result becomes “NG” resulted from the apparatus specification information or the inspection scenario having an error.

In detail, the automatic inspecting device 20 may read the response data stored in the memory 24 based on the inspection scenario (S801). Next, the automatic inspecting device 20 may determine success or failure or calculates the score value based on the response data and the expected data/expected operation, and describe the determination result or the score value in the inspection result data (S802). Note that since concrete contents of the inspection and the subsequent processings (S803 etc.) are similar to those of the automatic inspection, description thereof is omitted.

By conducting the off-line inspection, the (off-line) inspection can be conducted without connecting with the inspection target apparatus 10. Therefore, the inspection can be conducted also when the inspection target apparatus 10 is used for other uses. Further, since it is not necessary for the off-line inspection to wait for the response from the inspection target apparatus 10 unlike the normal automatic inspection, the inspection can be completed in a short period of time. Note that the off-line inspection can be performed only for an arbitrary part of the inspection scenario. Therefore, for example, the off-line inspection can be started from a given numerical position, or the off-line inspection can be performed only for the inspecting item of which the inspection result becomes “NG.”

As described above, the automatic inspecting device 20 of this embodiment may include the converting module 30, the outputting module 31, the acquiring module 32, and the inspecting module 42. The converting module 30 may convert processing to be performed by the inspection target apparatus 10 among the inspection scenarios including the processing to be performed by the inspection target apparatus 10 (specifically, the user's operational intention or the environmental data provided from the external apparatus) and the expected operation or the expected data of the inspection target apparatus, into the converted signal corresponding to the apparatus specification information (specifically, the operation signal or the input sensor data for the inspection target apparatus 10) (conversion step). The outputting module 31 may output the converted signal to the inspection target apparatus 10 (output step). The acquiring module 32 may acquire the response data (specifically, the display screen or the output sensor data) of the inspection target apparatus 10 obtained according to the converted signal (acquisition step). The inspecting module 42 may calculate the degree of matching of the response data with the expected operation or the expected data included in the apparatus specification information or the inspection scenario (specifically, determine success or failure or calculate the score value) (inspection step).

Thus, since the automatic inspecting device 20 has the function to convert the processing to be performed by the inspection target apparatus 10 into the converted signal, the inspection scenario can be described using the processing to be performed by the inspection target apparatus. Therefore, even if the apparatus specification information is changed, since it is not necessary to change the inspection scenario accordingly, the operator's burden can be reduced significantly.

Moreover, the automatic inspecting device 20 of this embodiment may be provided with the creating module 51 which creates or edits the apparatus specification information or the inspection scenario by analyzing the response data acquired by the acquiring module 32.

Thus, by creating the apparatus specification information based on the response data outputted from the inspection target apparatus 10, the apparatus specification information can be created easily and accurately.

Moreover, in the automatic inspecting device 20 of this embodiment, the outputting module 31 may autonomously repeat at least the processing to output the operation signal based on the fundamental information on the operation or the display. The creating module 51 may create the operation specification data of the inspection target apparatus 10 as the apparatus specification information.

Moreover, in the automatic inspecting device 20 of this embodiment, the outputting module 31 may autonomously repeat at least the processing to output the operation signal based on the fundamental information on the operation or the display. The creating module 51 may create the type of the display screen of the inspection target apparatus 10 and the data displayed by the display screen, as the apparatus specification information.

Therefore, since the automatic inspecting device 20 can autonomously and automatically create the operation specification data and the display specification data, without depending on the inspection scenario, the burden of creating the specifications can be reduced significantly. Moreover, as described above, these data can also be used for conversion etc. of the operational intention.

Moreover, in the automatic inspecting device 20 of this embodiment, the inspecting module 42 may determine success or failure, or calculate the score value, based on the response data acquired and stored beforehand, and the expected data included in the inspection scenario.

Therefore, the automatic inspection of the inspection target apparatus 10 can be performed, without using the inspection target apparatus 10.

Moreover, the automatic inspecting device 20 of this embodiment may include the timing determining module 41 which determines the timing at which the outputting module 31 outputs the operation signal or the input sensor data to the inspection target apparatus 10. After the timing determining module 41 detects that the inspection target apparatus 10 accepted the operation signal or the input sensor data, or that the inspection target apparatus 10 finished the processing based on the operation signal or the input sensor data, based on at least one of the display screen of the inspection target apparatus 10 and the response data or the sound generated from the inspection target apparatus 10, it may output the next operation signal or input sensor data to the inspection target apparatus 10.

Thus, since the period of time between a command output and the next command output can be shortened, the period of time required for the automatic inspection can be shortened.

Moreover, the automatic inspecting device 20 of this embodiment may be provided with the memory 24 and the editing module 52. The memory 24 may store the learning font data obtained by learning the font used by the inspection target apparatus 10. The editing module 52 may edit the learning font data. For the character for which the character recognition was failed or its probability is below the given threshold when analyzing the response data, the editing module 52 may correct and learn the learning font data using the response data.

Thus, since the font data is learned based on the display actually performed by the inspection target apparatus 10, the accuracy of the character recognition can be improved.

Although the suitable embodiment and modifications of the present disclosure are described above, the above configuration may be changed as follows, for example.

Although in the above embodiment the automatic inspecting device 20 detects that the processing of the inspection target apparatus 10 based on the command output from the outputting module 31 is finished in the processing illustrated in FIG. 9, the inspection target apparatus 10 receiving the command output from the outputting module 31 may be detected. In detail, if making a confirmation sound by the user interface 12 of the inspection target apparatus 10 being operated, the inspection target apparatus 10 receiving the command output from the outputting module 31 can be detected using the confirmation sound. Note that the inspection target apparatus 10 receiving the command output from the outputting module 31 may be detected based on a screen change of the inspection target apparatus 10, similar to the above embodiment.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Unless otherwise explicitly stated, numbers preceded by a term such as “approximately”, “about”, and “substantially” as used herein include the recited numbers, and also represent an amount close to the stated amount that still performs a desired function or achieves a desired result. For example, unless otherwise explicitly stated, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. An automatic inspecting device, comprising:
a hardware processor configured to:
convert processing to be performed by an inspection target apparatus into a converted signal corresponding to apparatus specification information on the inspection target apparatus;
output the converted signal to the inspection target apparatus;
acquire response data of the inspection target apparatus obtained according to the converted signal; and
calculate a degree of matching of the response data with an expected operation or an expected data included in the apparatus specification information or an inspection scenario including the processing, and the expected operation or the expected data of the inspection target apparatus.

2. The automatic inspecting device of claim 1, wherein the inspection scenario describes, as the processing to be performed by the inspection target apparatus, an operational intention of a user or environmental data provided from an external apparatus.

3. The automatic inspecting device of claim 1, wherein the hardware processor is further configured to convert the processing into an operation signal or input sensor data for the inspection target apparatus, as the converted signal.

4. The automatic inspecting device of claim 1, wherein the hardware processor is further configured to acquire a display screen of the inspection target apparatus or output sensor data, as the response data.

5. The automatic inspecting device of claim 1, the hardware processor is further configured to create or edit the apparatus specification information or the inspection scenario by analyzing the response data.

6. The automatic inspecting device of claim 5, wherein the hardware processor is further configured to:
repeat autonomously at least processing to output an operation signal based on fundamental information on operation or display, to the inspection target apparatus, and
create operation specification data of the inspection target apparatus as the apparatus specification information.

7. The automatic inspecting device of claim 5, wherein the hardware processor is further configured to:
repeat autonomously at least processing to output an operation signal based on fundamental information on operation or display, to the inspection target apparatus, and
create a type of a display screen of the inspection target apparatus and data displayed by the display screen, as the apparatus specification information.

8. The automatic inspecting device of claim 1, wherein the hardware processor is further configured to calculate the degree of matching of the response data acquired and stored beforehand with the expected operation or the expected data included in the apparatus specification information or the inspection scenario.

9. The automatic inspecting device of claim 1, wherein the hardware processor is further configured to determine success or failure or calculates a score value, as the degree of matching.

10. The automatic inspecting device of claim 1, wherein the hardware processor is further configured to output the next converted signal to the inspection target apparatus, after detecting that the inspection target apparatus accepted the converted signal, or that the inspection target apparatus finished the processing based on the converted signal, based on at least one of the display screen of the inspection target apparatus, and the response data or sound generated from the inspection target apparatus.

11. The automatic inspecting device of claim 1, wherein the hardware processor is further configured to correct and learn the learning font data using the response data for the character for which an error occurs in the character recognition when analyzing the response data, or the character of which a probability of the error is below a given threshold.

12. A automatic inspection method, comprising the steps of:
converting processing to be performed by an inspection target apparatus into a converted signal corresponding to apparatus specification information on the inspection target apparatus;
outputting the converted signal to the inspection target apparatus;
acquiring response data of the inspection target apparatus obtained according to the converted signal; and
calculating a degree of matching of the response data with an expected operation or an expected data included in the apparatus specification information or an inspection scenario including the processing, and the expected operation or the expected data of the inspection target apparatus.

13. A non-transitory computer-readable recording medium storing a control program causing a processor of an automatic inspecting device to execute processing, the processor configured to control operation of the device, the processing comprising:
converting processing to be performed by an inspection target apparatus into a converted signal corresponding to apparatus specification information on the inspection target apparatus;
outputting the converted signal to the inspection target apparatus;
acquiring response data of the inspection target apparatus obtained according to the converted signal; and
calculating a degree of matching of the response data with an expected operation or an expected data included in the apparatus specification information or an inspection scenario including the processing, and the expected operation or the expected data of the inspection target apparatus.
